(19) United States
(12) Patent Application Publication
(10) Pub. No.: US 2022/0414479 A1
(43) Pub. Date: Dec. 29, 2022

(54) CONTRADICTION DETECTION APPARATUS, CONTRADICTION DETECTION METHOD, AND COMPUTER-READABLE RECORDING MEDIUM

(71) Applicant: NEC Corporation, Minato-ku, Tokyo (JP)

(72) Inventors: Shiho HIRAKAWA, Tokyo (JP); Yoichi SASAKI, Tokyo (JP)

(73) Assignee: NEC Corporation, Minato-ku, Tokyo (JP)

(21) Appl. No.: 17/621,327

(22) PCT Filed: Jun. 27, 2019
(86) PCT No.: PCT/JP2019/025592

§ 371 Date: Dec. 21, 2021

(51) Int. Cl. G06N 5/02

(52) U.S. Cl. CPC G06N 5/02

(57) ABSTRACT

A contradiction detection apparatus includes: constructing a decision graph that has observed events as nodes and a transition relationship of each observed event as an edge, and outputs a boolean value of an observed event based on the knowledge base, receiving an observed event, eliminating an edge, which transitions to a side denying the observed event received, among edges connected to a node corresponding to the observed event received in the decision graph, determining whether both paths from a root node to a true leaf node and a false leaf node exist in the decision graph after the edge is eliminated, repeatedly causing a reception of the observed event, an elimination of the edge, and a determination of existence of the paths when it is determined that the paths exist, and deciding that the observed event is inconsistent with the knowledge base when determining that the paths doesn't exist.

### TECHNICAL FIELD

The present invention relates to a contradiction detection apparatus and a contradiction detection method for detecting contradictions in a derivation of hypotheses by applying inferential knowledge to observed events, and further relates to a computer-readable recording medium that includes recorded thereon, a program for realizing the apparatus and the method.

### BACKGROUND ART

Conventionally, a method called abduction has been known as a type of logical inference. Abduction is a method of deriving the best hypothesis from given knowledge (rules) and observed events (obtained facts). For example, it is assumed that “A=>B (if A is true, then B is true)” exists as knowledge, and “B is true” is acquired as an observed event. In this case, “A is true” is obtained as a hypothesis by inference.

The above abduction has been attempted to be performed by computers (see, for example, Patent Document 1). Abduction by computers makes it possible to infer various situations based on information obtained from facts. Abduction by computers is therefore useful for planning store openings, criminal investigations, disaster evacuation, environmental management, or the like, and the use of abduction can be expected to improve the accuracy of simulations.

### LIST OF RELATED ART DOCUMENTS

### Patent Document

Patent Document 1: Japanese Patent Laid-Open Publication No. 2000-242499

### SUMMARY OF INVENTION

### Problems to be Solved by the Invention

However, in the abduction, if the observed event is inconsistent with the knowledge, the correct hypothesis cannot be derived. In such cases, there is a risk of wasting time by performing useless inferences, and also of not being able to derive correct inference results. Therefore, it is desirable to find a contradiction of the observed event.

An example of object of the present invention is to provide a contradiction detection apparatus, a contradiction detection method and a computer-readable recording medium that can find a contradiction of an observed event.

### Means for Solving the Problems

In order to achieve the above object, a contradiction detection apparatus in one aspect of the present invention detects whether an observed event is inconsistent with a knowledge base,

the contradiction detection apparatus includes:

a construction means for constructing a decision graph that has observed events as nodes and a transition relationship of each observed event as an edge, and outputs a boolean value of an observed event based on the knowledge base,

a reception means for receiving an observed event,

an elimination means for eliminating an edge, which transitions to a side denying the observed event received by the reception means, among edges connected to a node corresponding to the observed event received by the reception means in the decision graph,

a determination means for determining whether both paths from a root node to a true leaf node and a false leaf node exist in the decision graph after the edge is eliminated by the elimination means,

a repetition means for causing the reception means, the elimination means, and the determination means to repeatedly execute processing when the determination means determines that the paths exist, and

a decision means for deciding that the observed event is inconsistent with the knowledge base when the determination means determines that the paths does not exist.

Further, in order to achieve the above object, a contradiction detection method in one aspect of the present invention detects whether an observed event is inconsistent with a knowledge base,

the contradiction detection method includes:

constructing a decision graph that has observed events as nodes and a transition relationship of each observed event as an edge, and outputs a boolean value of an observed event based on the knowledge base,

receiving an observed event,

eliminating an edge, which transitions to a side denying the observed event received, among edges connected to a node corresponding to the observed event received in the decision graph,

determining whether both paths from a root node to a true leaf node and a false leaf node exist in the decision graph after the edge is eliminated,

repeatedly executing a reception of the observed event, an elimination of the edge, and a determination of existence of the paths when it is determined that the paths exist, and

deciding that the observed event is inconsistent with the knowledge base when it is determined that the paths does not exist.

Further, in order to achieve the above object, a computer-readable recording medium according to an example aspect of the invention includes a program recorded thereon, the program including instructions that cause a computer, which detects whether an observed event is inconsistent with a knowledge base, to execute:

constructing a decision graph that has observed events as nodes and a transition relationship of each observed event as an edge, and outputs a boolean value of an observed event based on the knowledge base,

receiving an observed event,

eliminating an edge, which transitions to a side denying the observed event received, among edges connected to a node corresponding to the observed event received in the decision graph,

determining whether both paths from a root node to a true leaf node and a false leaf node exist in the decision graph after the edge is eliminated,

repeatedly executing a reception of the observed event, an elimination of the edge, and a determination of existence of the paths when it is determined that the paths exist, and

deciding that the observed event is inconsistent with the knowledge base when it is determined that the paths does not exist.

### Advantageous Effects of the Invention

According to the present invention, it is possible to find the contradiction of the observed event with respect to the knowledge base.

### BRIEF DESCRIPTION OF THE DRAWINGS

FIG. 1 is a diagram showing a configuration of a contradiction detection apparatus according to an example embodiment 1.

FIG. 2 is a block diagram specifically showing a configuration of the contradiction detection apparatus according to the example embodiment 1.

FIG. 3 is a block diagram specifically showing a configuration of a minimal unsatisfiable set detection apparatus in the contradiction detection apparatus.

FIG. 4 is a diagram showing a decision graph constructed by a construction unit.

FIG. 5 is a diagram for explaining processing executed by a reception unit, an elimination unit, a determination unit, and a repetition unit.

FIG. 6 is a diagram for explaining processing executed by the reception unit, the elimination unit, the determination unit, and the repetition unit.

FIG. 7 is a diagram for explaining processing executed by the reception unit, the elimination unit, the determination unit, and the repetition unit.

FIG. 8 is a diagram showing a decision graph to which path numbers are assigned.

FIG. 9 is a diagram showing observed events and path numbers associated with the observed events.

FIG. 10 is a flow diagram showing a process executed by the contradiction detection apparatus according to the example embodiment 1.

FIG. 11 is a flow diagram showing a minimal set covering calculation process.

FIG. 12 is a block diagram specifically showing a configuration of a contradiction detection apparatus according to an example embodiment 2.

FIG. 13 is a diagram for explaining processing of a link operation unit and a label operation unit.

FIG. 14 is a diagram for explaining processing of a label operation unit.

FIG. 15 is a flow diagram showing a process executed by the contradiction detection apparatus according to the example embodiment 1.

FIG. 16 is a flow diagram showing determination process.

FIG. 17 is a diagram for explaining the determination process of FIG. 16.

FIG. 18 is a diagram for explaining the determination process of FIG. 16.

FIG. 19 is a diagram for explaining the determination process of FIG. 16.

FIG. 20 is a block diagram showing an example of a computer that realizes the contradiction detection apparatuses according to the example embodiments 1 and 2.

### EXAMPLE EMBODIMENTS

Hereinafter, a contradiction detection apparatus, a contradiction detection method, and a computer-readable recording medium according to the example embodiment of the present invention will be described with reference to the drawings.

### Example Embodiment 1

### [Apparatus Configuration]

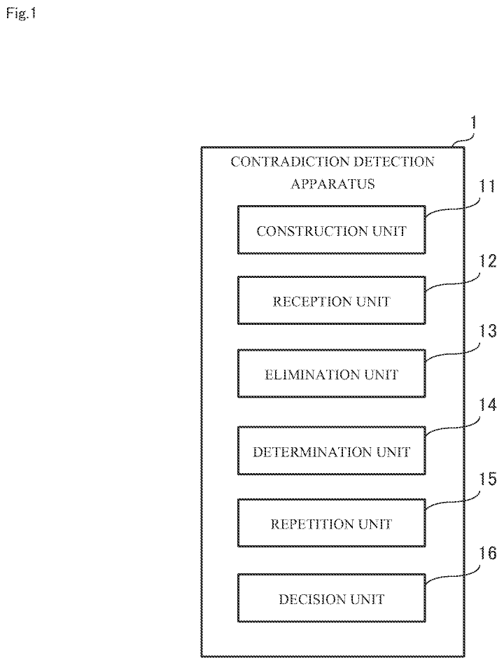

First, a schematic configuration of the contradiction detection apparatus according to the example embodiment 1 will be described with reference to FIG. 1. FIG. 1 is a diagram showing a configuration of the contradiction detection apparatus 1 according to the example embodiment 1.

The contradiction detection apparatus 1 is an apparatus that detects whether an observed event is inconsistent with a knowledge base. The contradiction detection apparatus 1 includes a construction unit 11, a reception unit 12, an elimination unit 13, a determination unit 14, a repetition unit 15, and a decision unit 16.

The construction unit 11 constructs a decision graph, which has observed events as nodes and a transition relationship of each observed event as an edge and outputs a boolean value of the observed event based on the knowledge base.

The reception unit 12 receives the observed event.

The elimination unit 13 eliminates the edge, which transitions to a side denying the observed event, among the edges connected to the node corresponding to the observed event received by the reception unit 12 in the decision graph.

The determination unit 14 determines whether both paths from a root node to a true leaf node and a false leaf node exist in the decision graph after the edge is eliminated by the elimination unit 13.

The repetition unit 15 causes the reception unit 21, the elimination unit 13, and the determination unit 14 to repeatedly execute processing when the determination unit 14 determines that the paths exist.

The decision unit 16 decides that the observed event is inconsistent with the knowledge base when the determination unit 14 determines that the paths does not exist.

According to the contradiction detection apparatus 1 of the above example embodiment 1, it is possible to detect that the observed event is inconsistent with the knowledge base.

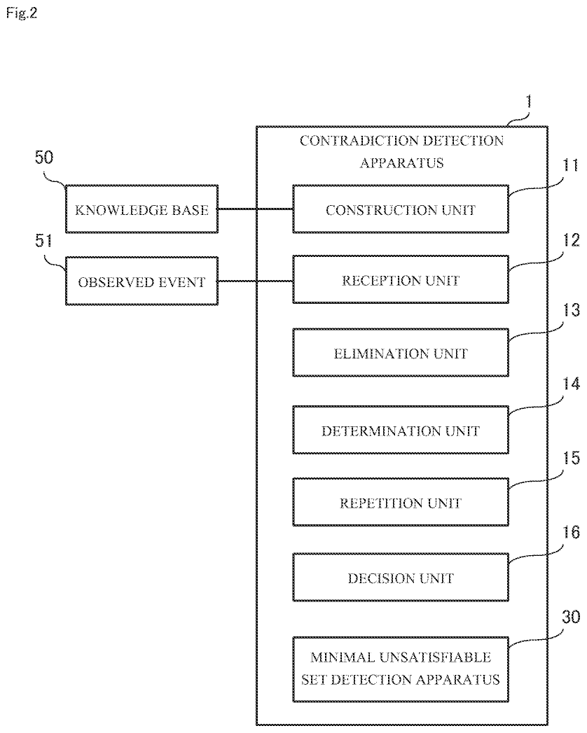

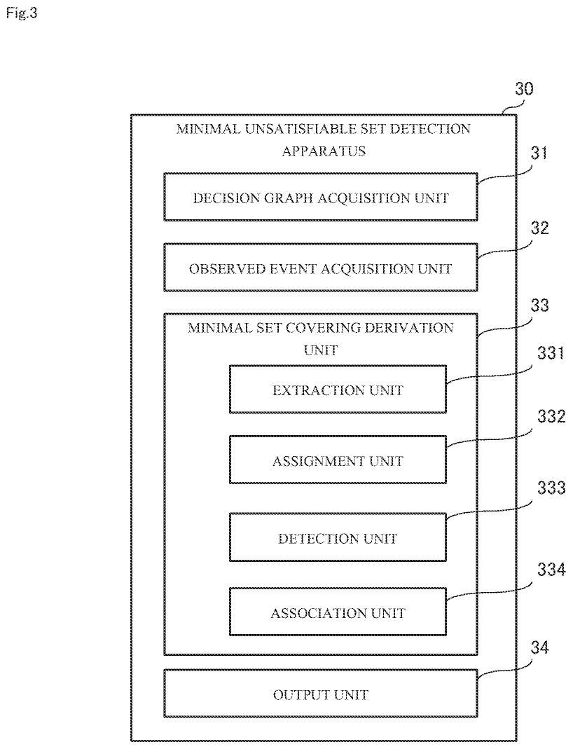

Subsequently, the configuration and functions of the contradiction detection apparatus 1 according to the example embodiment 1 will be specifically described. FIG. 2 is a block diagram specifically showing the configuration of the contradiction detection apparatus 1 according to the example embodiment 1. FIG. 3 is a block diagram specifically showing a configuration of a minimal unsatisfiable set detection apparatus 30 in the contradiction detection apparatus 1.

The contradiction detection apparatus 1 includes the minimal unsatisfiable set detection apparatus 30 in addition to the construction unit 11, the reception unit 12, the elimination unit 13, the determination unit 14, the repetition unit 15, and the decision unit 16 described above.

The construction unit 11 constructs the decision graph based on a knowledge base 50. The knowledge base 50 is data for performing the abduction. The knowledge base 50 is stored in a storage device not shown in the figure. The storage device may be provided outside the contradiction detection apparatus 1 or may be provided in the contradiction detection apparatus 1.

The knowledge base 50 is expressed, for example, by an implication relation rule of a first-order predicate logic formula. The knowledge base 50 is expressed in the form of, for example, “pre-state (premise)=>post-state (conclusion)”. This form indicates that if the pre-state, which is the premise to be observed, is true, then the post-state, which is the inevitable conclusion, is derived. In this form, the “post-state” is a necessary condition for the “pre-state” to be true. The “pre-state” is a sufficient condition for the “post-state” to be true. The sufficient condition can also be expressed as a conjunction of multiple propositions. For example, the knowledge base 50 may be expressed as “pre-state (premise) A action=>post-state”.

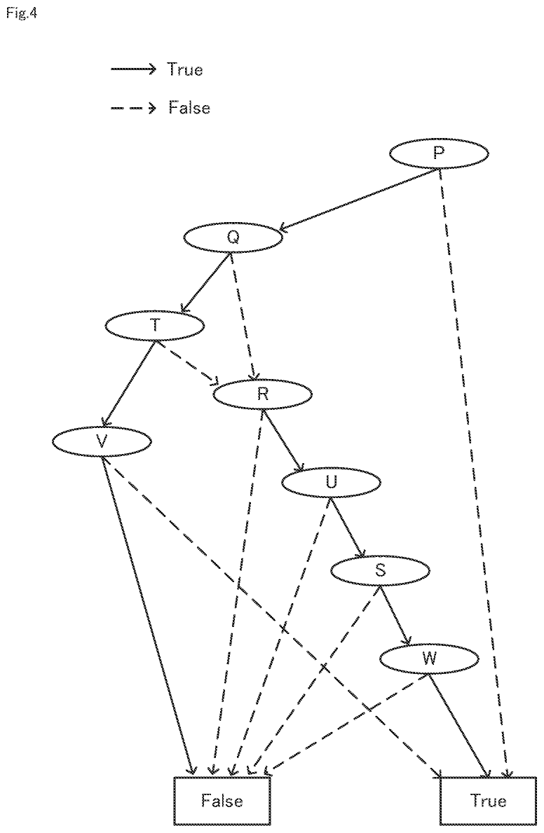

FIG. 4 is a diagram showing a decision graph constructed by the construction unit 11. The decision graph shown in FIG. 4 is a BDD (Binary Decision Diagram) that represents the knowledge base 50. This decision graph consists of nodes and edges. Each node is an event to be observed. Each edge connects a node to another node and represents a transition relationship between the nodes. In this decision graph, a root node is a node that has no parent node, and is node “P”. In addition, leaf nodes are nodes that do not have any child nodes, and in FIG. 4, they are the “True” and “False” nodes. From this decision graph, a boolean value of an observed event 51, that is, “True” or “False” is derived. The decision graph may be a ZDD (Zero-suppressed Binary Decision Diagram) or SDD (Sentential Decision Diagram).

With reference to FIGS. 5 to 7 and assuming that the events “U”, “¬S”, “W”, “¬T” and “P” are observed in this order, the reception unit 12, the elimination unit 13, the determination unit 14, and the repetition unit 15 will be described. FIG. 5, FIG. 6 and FIG. 7 are diagrams for explaining processing executed by the reception unit 12, the elimination unit 13, the determination unit 14, and the repetition unit 15.

The reception unit 12 receives the observed event 51. The elimination unit 13 eliminates the edge, which transitions to a side denying the observed event 51, among the edges connected to the node corresponding to the observed event 51 received by the reception unit 12. The edge that transitions to the side denying the observed event 51 is, for example, when the observed event 51 is “U”, the edge of “False” (the edge (A) in FIG. 5) connected to the node “U” corresponding to the observed event 51.

The determination unit 14 determines reachability in the decision graph after the edge is eliminated by the elimination unit 13. Reachability is the presence or absence of a first path from the root node to the leaf node “True” and a second path from the root node to the leaf node “False”. The determination unit 14 determines that there is reachability when the first path and the second path exist, and determines that there is no reachability when the first path or the second path does not exist. In the decision graph shown in FIG. 5, even if the edge (A) is eliminated, the first path and the second path still exist. Therefore, the determination unit 14 determines that there is reachability.

When the determination unit 14 determines that there is reachability, the repetition unit 15 causes the reception unit 12, the elimination unit 13, and the determination unit 14 to execute the processing again. Specifically, the reception unit 12 receives “¬S”, which is the next observed event 51. The elimination unit 13 eliminates the edge of “True” connected to the node “S” (the edge (B) in FIG. 6). The determination unit 14 determines the reachability in the decision graph after the edge is eliminated by the elimination unit 13.

FIG. 7 shows the decision graph after the elimination unit 13 eliminates the “False” edge connected to the node “P” in the case where the events “U”, “¬S”, “W”, “¬T”, and “P” are observed in this order. In the decision graph shown in FIG. 7, there is no first path from the root node to the leaf node “True”. That is, the determination unit 14 determines that there is no reachability. The decision graph of FIG. 7 means that “False” is always output no matter what kind of event is observed thereafter. It is noted that the determination method by the determination unit 14 is not particularly limited.

Return to FIG. 2. When the determination unit 14 determines that there is no reachability, the decision unit 16 decides that the observed events 51 (events “U”, “¬S”, “W”, “¬T”, “P”) received so far are inconsistent with the knowledge base.

The minimal unsatisfiable set detection apparatus 30 is an apparatus that detects a minimal set covering from multiple observed events 51 that are inconsistent with the knowledge base 50. The minimal unsatisfiable set detection apparatus 30 may be independent of the contradiction detection apparatus 1. As shown in FIG. 3, the minimal unsatisfiable set detection apparatus 30 includes a decision graph acquisition unit 31, an observed event acquisition unit 32, a minimal set covering derivation unit 33, and an output unit 34.

The decision graph acquisition unit 31 acquires the decision graph constructed by the construction unit 11.

The observed event acquisition unit 32 acquires a plurality of observed events 51 decided to be inconsistent with the knowledge base by the decision unit 16. In the example embodiment 1, the plurality of observed events 51 decided to be inconsistent are “U”, “¬S”, “W”, “¬T”, and “P”.

The minimal set covering derivation unit 33 converts the plurality of observed events 51 acquired by the observed event acquisition unit 32 into a minimal set covering problem using a decision graph, and obtains a minimal set covering. The minimal set covering derivation unit 33 includes an extraction unit 331, an assignment unit 332, a detection unit 333, and an association unit 334.

The extraction unit 331 extracts all of the first paths from the root node to the leaf node “True” or the second paths from the root node to the leaf node “False” in the decision graph. The extraction unit 331 extracts all of the first or second paths for which it is determined that reachability does not exist. In the example embodiment 1, the determination unit 14 determines that there is no reachability of the first path. In this case, the extraction unit 331 extracts all of the first paths.

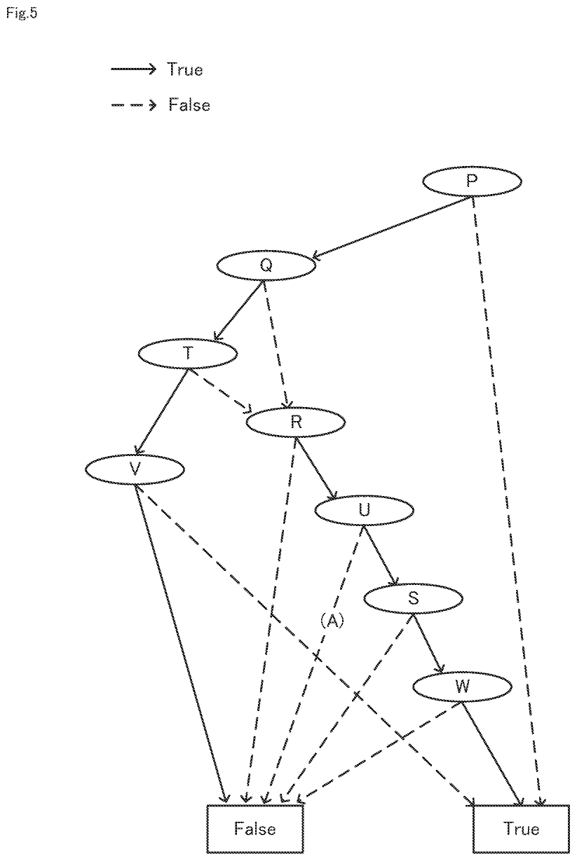

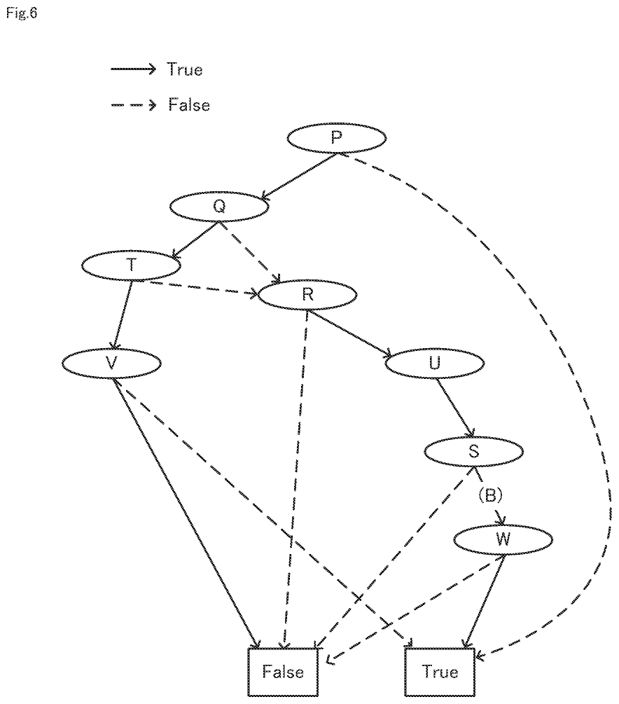

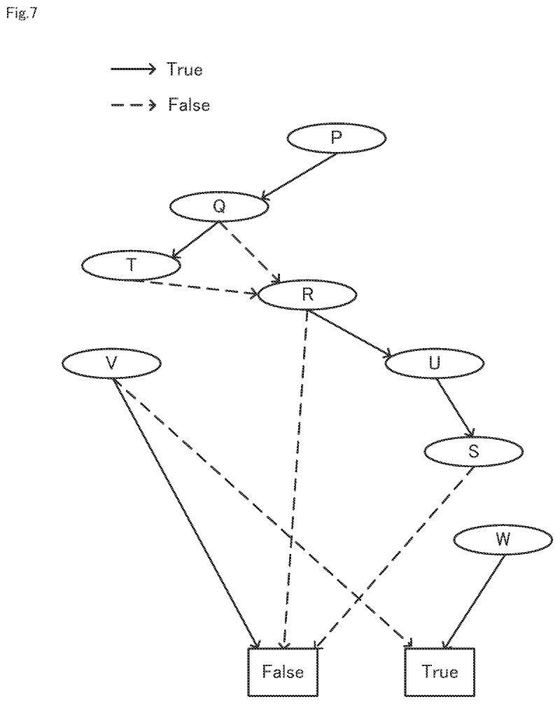

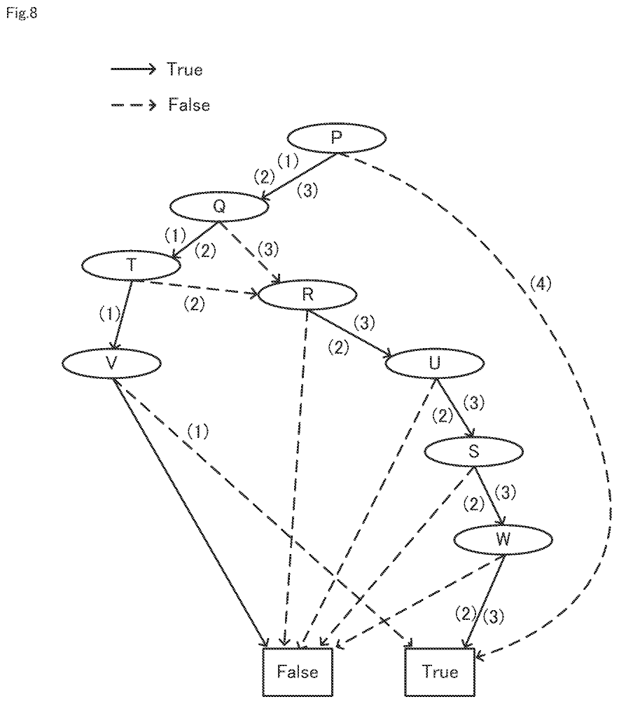

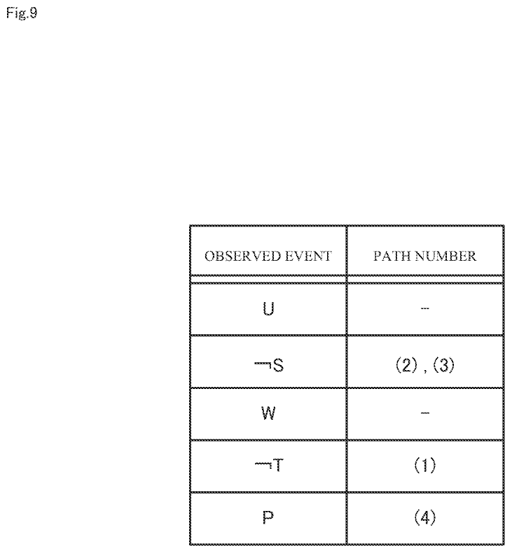

The assignment unit 332 assigns path numbers to all the first paths extracted by the extraction unit 331. FIG. 8 is a diagram showing a decision graph to which path numbers are assigned. As shown in FIG. 8, the assignment unit 332 assigns the path numbers (1) to (4) to each edge constituting the first path.

The detection unit 333 detects which of the plurality of observed events 51 acquired by the observed event acquisition unit 32 is observed to block the first paths to which path numbers (1) to (4) are assigned. For example, when the observed event 51 is “¬S”, the first paths with path numbers (2) and (3) are blocked.

The association unit 334 associates the observed event 51 detected by the detection unit 333 with the path number of the first path blocked by the observed event 51. FIG. 9 is a diagram showing observed events 51 and path numbers associated with the observed events 51.

The minimal set covering derivation unit 33 obtains the minimal set covering of all path numbers from the observed events 51 to which the path numbers are associated. That is, the minimal set covering derivation unit 33 finds the smallest combination of observed events 51 that satisfies all the path numbers (1) to (4). In the case of FIG. 9, the combination of the events “¬S”, “¬T”, and “P” satisfies all the path numbers (1) to (4). This means that the smallest combination of the observed events 51, which are inconsistent with the knowledge base 50, is “¬S”, “¬T”, and “P”. In this way, the reliability of the contradiction detection can be improved by obtaining the minimal set covering from the plurality of observed events 51 that are determined to be inconsistent with the knowledge base 50.

The output unit 34 outputs the result of the minimal set covering obtained by the minimal set covering derivation unit 33. Note that, when the decision unit 16 detects a contradiction, the output unit 34 may output “U”, “¬S”, “W”, “¬T”, and “P” as the observed events 51 received by the reception unit 12 before the contradiction is decided. Further, the output unit 34 may output to the outside of the contradiction detection apparatus 1, or may output to a display device when the contradiction detection apparatus 1 includes the display device, for example.

### [Apparatus Operations]

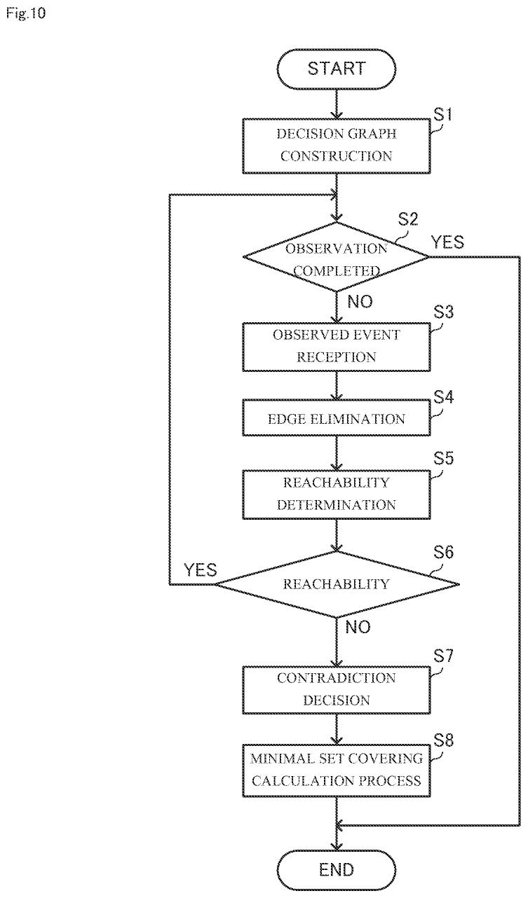

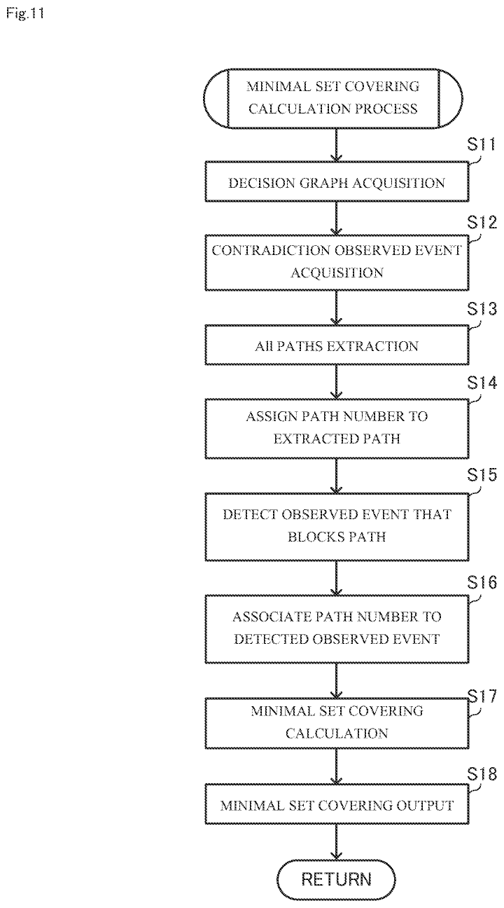

Next, the operation of the contradiction detection apparatus 1 according to the example embodiment 1 will be described with reference to FIG. 10. FIG. 10 is a flow diagram showing a process executed by the contradiction detection apparatus 1 according to the example embodiment 1. In the example embodiment 1, the contradiction detection method is implemented by operating the contradiction detection apparatus 1. Therefore, the description of the contradiction detection method in the example embodiment 1 will be replaced with the following description of the operation of the contradiction detection apparatus 1.

The construction unit 11 acquires the knowledge base 50 and constructs a decision graph (S1). Next, the reception unit 12 determines whether the observation of the event is completed (S2), and if not (S2: NO), receives one observed event 51 (S3). When the observation of the event is completed (S2: YES), this process is completed.

In the decision graph constructed in S1, the elimination unit 13 eliminates the edge, which transitions to the side denying the observed event 51, among the edges connected to the node corresponding to the observed event 51 received in S3, as described in FIG. 5 (S4). Then, the determination unit 14 determines the reachability in the decision graph after the edge is eliminated in S4 (S5).

When there is reachability (S6: YES), the repetition unit 15 causes the reception unit 12, the elimination unit 13, and the determination unit 14 to repeatedly execute each of the processes S2 to S5. When there is no reachability (S6: NO), the decision unit 16 decides that the observed events 51 received so far is inconsistent with the knowledge base 50 (S7). Then, the minimal unsatisfiable set detection apparatus 30 executes the minimal set covering calculation process (S8).

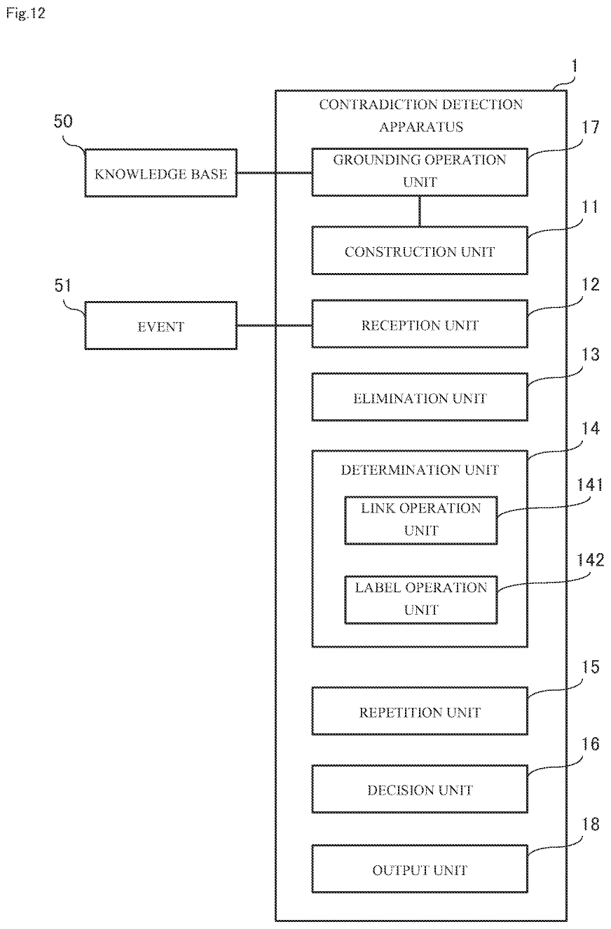

FIG. 11 is a flow diagram showing a minimal set covering calculation process.

The decision graph acquisition unit 31 acquires the decision graph constructed by the construction unit 11 (S11). The observed event acquisition unit 32 acquires the plurality of observed events 51 decided to be inconsistent by the decision unit 16 (S12). In the decision graph acquired in S11, the extraction unit 331 of the minimal set covering derivation unit 33 extracts all of the first paths from the root node to the leaf node “True” or the second paths from the root node to the leaf node “False” (S13).

As shown in FIG. 8, the assignment unit 332 of the minimal set covering derivation unit 33 assigns path numbers to the first paths or the second paths extracted in S13 (S14). Next, the detection unit 333 of the minimal set covering derivation unit 33 detects the observed event 51, which blocks the first path to which the path number is assigned, from the plurality of observed events 51 (S15). Then, as shown in FIG. 9, the association unit 334 of the minimal set covering derivation unit 33 associates the observed event 51 detected in S15 with the path number of the path to be blocked (S16).

The minimal set covering derivation unit 33 calculates the minimal set covering of all path numbers from the observed events 51 to which the path numbers are associated in S16 (S17). Then, the output unit 34 outputs the calculated minimal set covering (S18).

Note that, if the contradiction detection apparatus 1 does not include the minimal unsatisfiable set detection apparatus 30, the above processes S11 to S17 may be omitted. In this case, the contradiction detection apparatus 1 may include an output unit, and after determining in S7 of FIG. 10 that the received observed event 51 is inconsistent with the knowledge base 50, the contradiction detection apparatus 1 may output the observed event 51.

### [Program]

It is sufficient for the program according to the example embodiment 1 of the present invention to be a program that causes a computer to execute steps S1 to S8 shown in FIG. 10. The contradiction detection apparatus 1 and the contradiction detection method according to the example embodiment 1 can be realized by installing this program in the computer and executing this program. In this case, a processor of the computer functions as the construction unit 11, the reception unit 12, the elimination unit 13, the determination unit 14, the repetition unit 15, and the decision unit 16, and performs processing.

Also, the program according to the example embodiment 1 may be executed by a computer system constituted by a plurality of computers. In this case, for example, each computer may function as any of the construction unit 11, the reception unit 12, the elimination unit 13, the determination unit 14, the repetition unit 15, and the decision unit 16.

### Effect in the Example Embodiment 1

According to the contradiction detection apparatus 1 according to the example embodiment 1, it is possible to find the contradiction of the observed event 51 with respect to the knowledge base 50.

### Example Embodiment 2

Next, a contradiction detection apparatus, a contradiction detection method, and a computer-readable recording medium according to the example embodiment 2 of the present invention will be described with reference to the drawings. In the example embodiment 2, the method of determining the reachability with respect to the knowledge base is different from the example embodiment 1. The differences will be described below. Note that in the following, the same configuration as that of the example embodiment 1 will be described with the same reference numerals. Further, the contradiction detection apparatus of the example embodiment 2 does not include the minimal unsatisfiable set detection apparatus 30.

### [Apparatus Configuration]

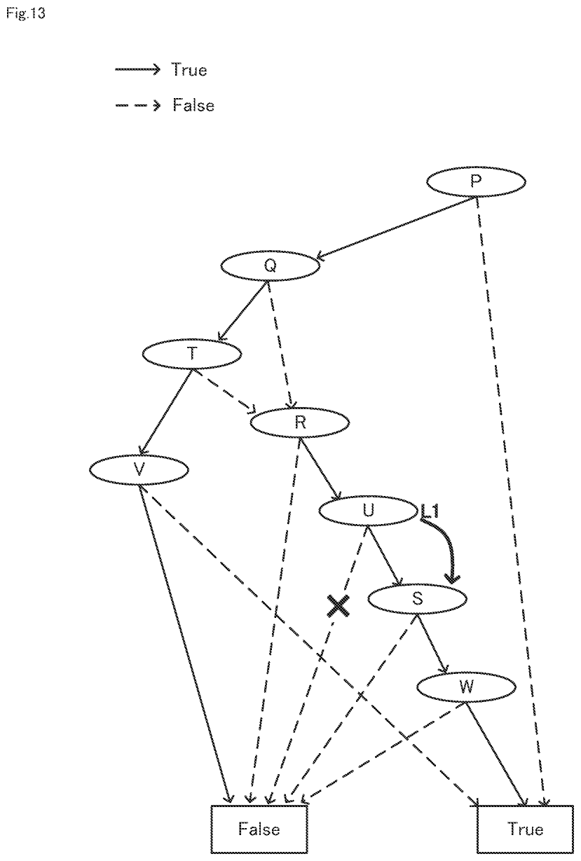

FIG. 12 is a block diagram specifically showing a configuration of a contradiction detection apparatus 2 according to the example embodiment 2.

The contradiction detection apparatus 2 includes the construction unit 11, the reception unit 12, the elimination unit 13, the determination unit 14, the repetition unit 15, the decision unit 16, a grounding operation unit 17, and an output unit 18.

The grounding operation unit 17 performs a grounding operation based on the Herbrand universe of the knowledge base 50. As described in the example embodiment 1, the knowledge base 50 is expressed by the implication relation rule of the first-order predicate logic formula. The Herbrand universe is a region where constants that can be assigned in the variables of each predicate are fixed for the first-order predicate logic formula. The grounding operation is a process of substituting the constants of the Herbrand universe into the first-order predicate logic formula so that it can be treated as a propositional logic formula.

For example, if there is a predicate called Eat (people, food), “people” and “food” are variables of the predicate. The Herbrand universe is “people={Andy, Bob, Cathy}”, “food={Donuts, Eggs, Fish}” and so on. In this case, the grounding operation generates Eat (Andy, Donut), Eat (Andy, Egg), Eat (Cath, Fish) and the like as propositional logic formula.

The construction unit 11 constructs a decision graph from the propositional logic formula generated by the grounding operation unit 17. In the example embodiment 2, the construction unit 11 constructs the decision graph shown in FIG. 4, as in the example embodiment 1.

The reception unit 12 and the elimination unit 13 are the same as those in the example embodiment 1.

The determination unit 14 includes a link operation unit 141 and a label operation unit 142.

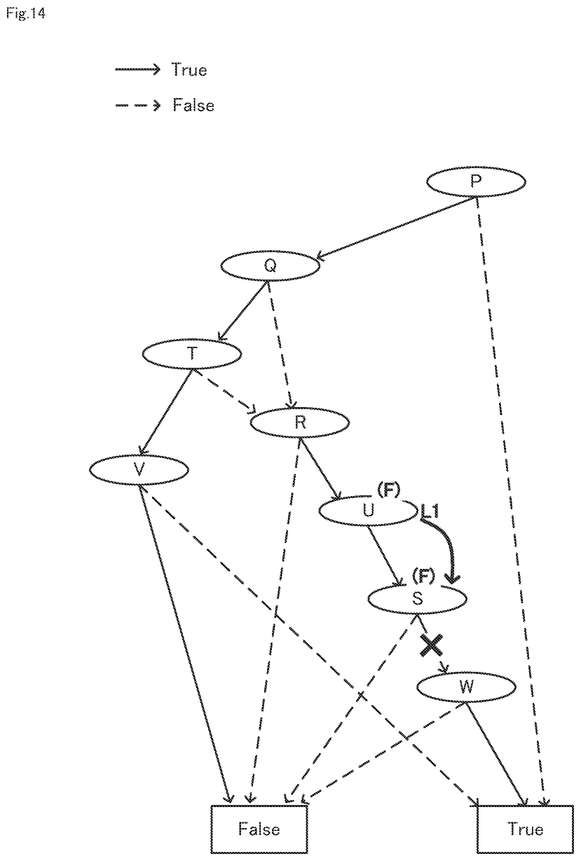

FIG. 13 is a diagram for explaining processing of the link operation unit 141.

For a node having only one internal node as a child node in the decision graph in which the edge is eliminated by the elimination unit 13, the link operation unit 141 puts a link to the one internal node. The internal node is a node that has child node. For example, when the observed event 51 is “U”, the elimination unit 13 eliminates the edge of “False” connected to the node “U”. In this case, the “one internal node” is the node “S”, and the “node having only one internal node” is the node “U”. The link operation unit 141 puts the link L1 to the node “S” on the node “U”.

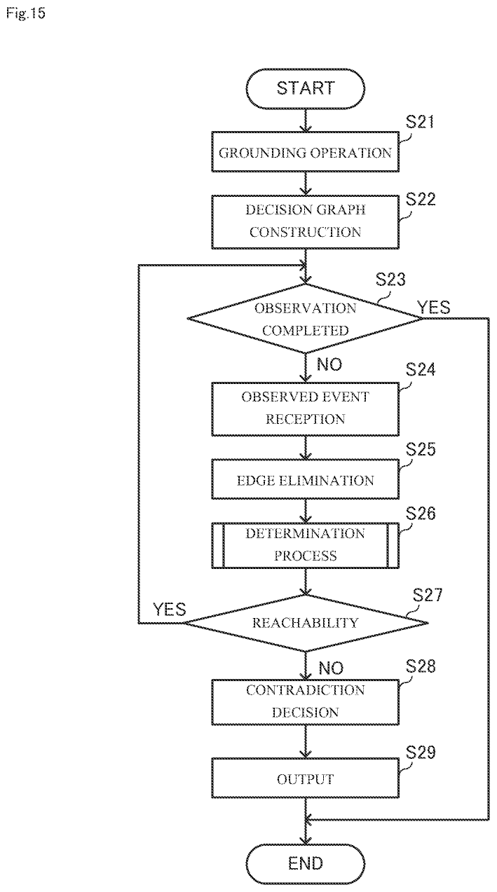

FIG. 14 is a diagram for explaining processing of a label operation unit 142. The decision graph shown in FIG. 14 is the graph after the elimination unit 13 eliminates the edge of “False” connected to the node “U” in FIG. 13.

For a node having only one leaf node as a final transition destination, the label operation unit 142 attaches a label of “True” or “False” corresponding to the one leaf node. For example, when the observed event 51 is “¬S”, the elimination unit 13 eliminates the edge of “True” connected to the node “S”. As a result, the node “S” transitions only to the leaf node “False”. The label operation unit 142 attaches a “False” label (represented by (F) in FIG. 14) to the node “S”.

Further, when the final transition destination of a parent node of the labeled node is only the same leaf node as the final transition destination of the labeled node, the label operation unit 142 also attaches the same label to the parent node. In the above example, a parent node of the node “S” is the node “U”. The transition destination of the node “U” is only the node “S”, and the node “S” transitions only to the leaf node “False”. Therefore, the final transition destination of the node “U” is the leaf node “False”. In this case, the label operation unit 142 also attaches a “False” label to the node “U”.

When the root node (node “P”) is labeled by the label operation unit 142, the determination unit 14 determines that both paths from the root node to the “True” and “False” leaf nodes do not exit. That is, in this case, the determination unit 14 determines that there is no reachability. On the other hand, when the root node is not labeled, the determination unit 14 determines that both paths from the root node to the “True” and “False” leaf nodes exist. That is, in this case, the determination unit 14 determines that there is reachability.

The repetition unit 15 causes the reception unit 12, the elimination unit 13, and the determination unit 14 to execute the processing again when the determination unit 14 determines that there is reachability.

### [Apparatus Operations]

Next, the operation of the contradiction detection apparatus 2 according to the example embodiment 2 will be described with reference to FIG. 14. FIG. 15 is a flow diagram showing the process executed by the contradiction detection apparatus 2 according to the example embodiment 2. In the example embodiment 2, the contradiction detection method is implemented by operating the contradiction detection apparatus 2. Therefore, the description of the contradiction detection method in the example embodiment 2 will be replaced with the following description of the operation of the contradiction detection apparatus 2.

First, the grounding operation unit 17 generates the propositional logic formula by performing the grounding operation based on the Herbrand universe of the knowledge base 50 (S21). The construction unit 11 constructs the decision graph from the propositional logic formula generated in S21 (S22). Next, the reception unit 12 determines whether the observation of the event is completed (S23), and if not (S23: NO), receives one observed event 51 (S24). When the observation of the event is completed (S23: YES), this process is completed.

In the decision graph constructed in S21, the elimination unit 13 eliminates the edge, which transitions to the side denying the observed event 51, among the edges connected to the node corresponding to the observed event 51 received in S23 (S25). Then, the determination unit 14 performs determination process to determine the reachability in the decision graph after the edge is eliminated (S26). The determination process is a process of attaching the link or the label to the node, which will be described in detail later.

When there is reachability (S27: YES), the repetition unit 15 causes the reception unit 12, the elimination unit 13, and the determination unit 14 to repeatedly execute each of the processes S23 to S26. When there is no reachability (S27: NO), the decision unit 16 decides that the received observed events 51 is inconsistent with the knowledge base 50 (S28). Then, the output unit 18 outputs the observed event 51 received by the reception unit 12 before the contradiction is decided (S29).

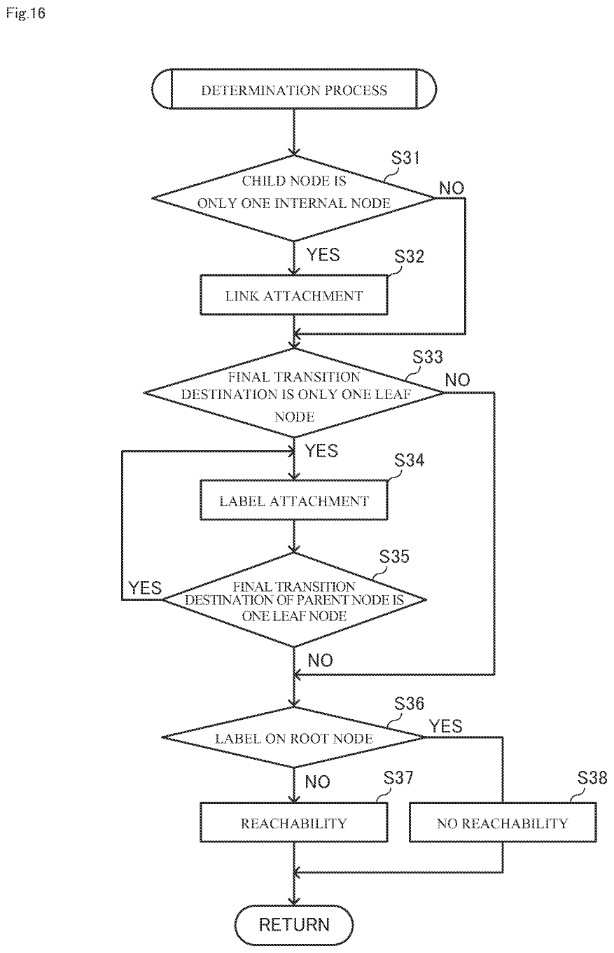

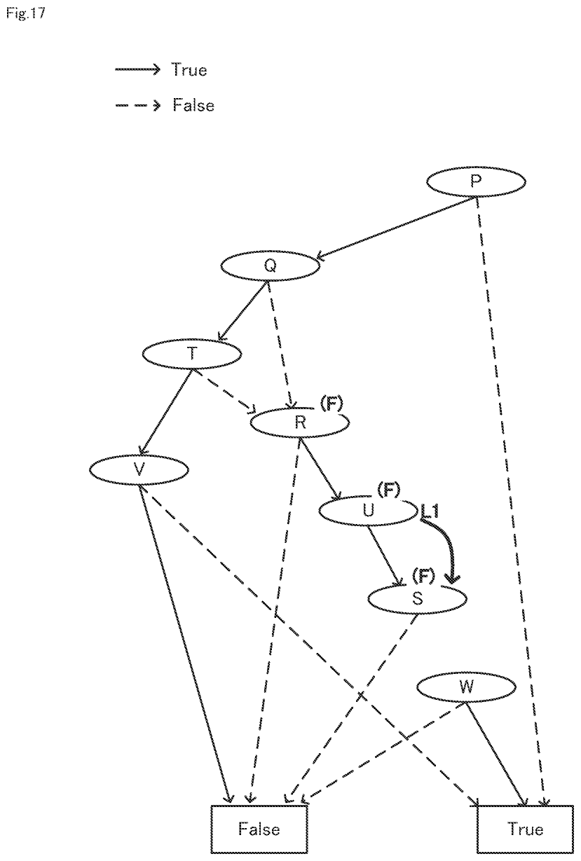

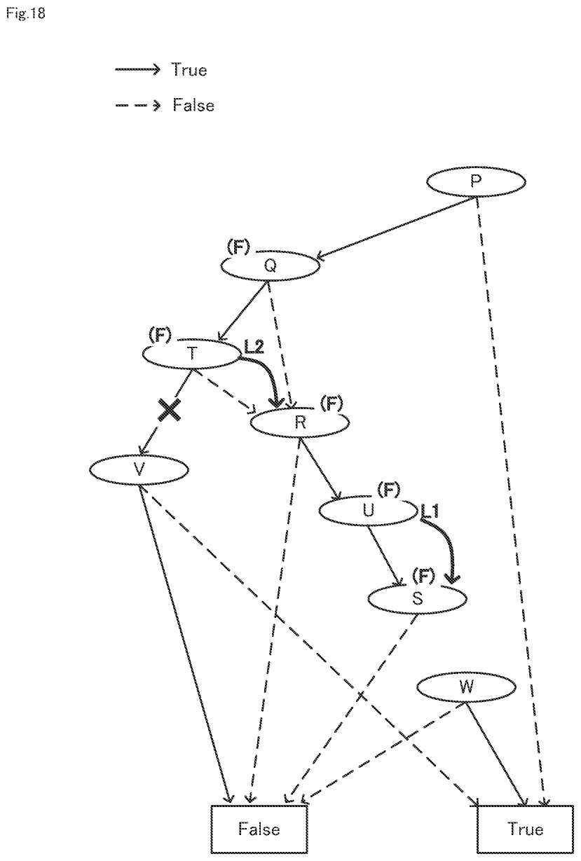

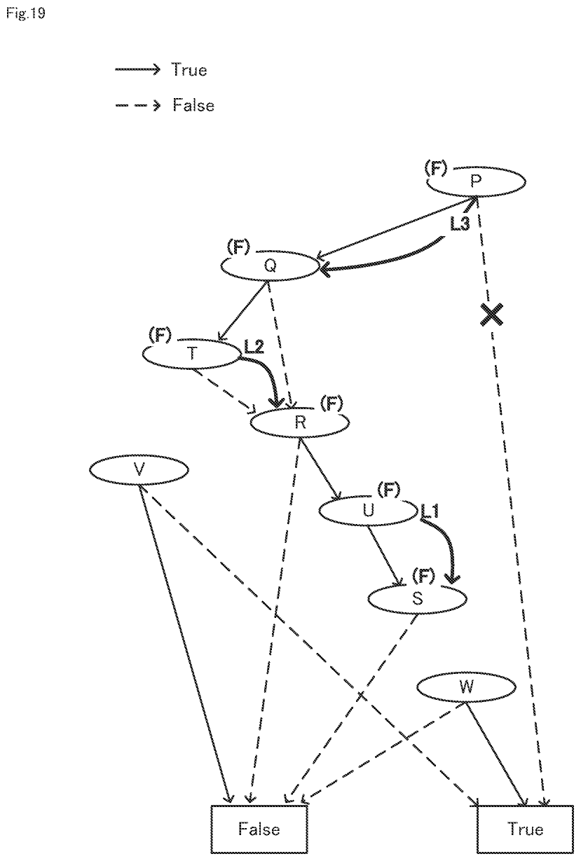

FIG. 16 is the flow diagram showing determination process. In the following, it will be described assuming that the events “U”, “¬S”, “¬T”, and “P” are observed in this order with reference to FIGS. 13, 14, and 17 to 19. FIG. 17, FIG. 18 and FIG. 19 are diagrams for explaining the determination process of FIG. 16.

(Case where Observed Event 51 is “U”)

When the observed event 51 is “U”, the edge of “False” connected to the node “U” is eliminated in S25 of FIG. 25. In the decision graph after the elimination, the link operation unit 141 determines whether the child node of the node “U” is only one internal node (S31). As shown in FIG. 13, the child node of the node “U” is only the node “S”. In this case (S31: YES), the link operation unit 141 attaches the link L1 to the node “S” on the node “U” (S32).

The label operation unit 142 determines whether the final transition destination of the node “U” is the one leaf node (S33). As shown in FIG. 13, the node “U” is reachable to both the leaf node “True” and the leaf node “False”. In this case (S33: NO), the determination unit 14 determines whether the label is attached to the root node (S36). The determination unit 14 determines whether the label is attached to the root node (S36). As shown in FIG. 13, the root node is not labeled. In this case (S36: NO), the determination unit 14 determines that there is reachability (S37).

(Case where Observed Event 51 is “¬S”)

When the observed event 51 is “¬S”, the edge of “True” connected to the node “S” is eliminated in S25 of FIG. 15. In the decision graph after the elimination, the link operation unit 141 determines whether the child node of the node “S” is only one internal node (S31). As shown in FIG. 14, the child node of the node “S” is the leaf node “False” which is not an internal node. In this case (S31: NO), the process proceeds to S33.

The label operation unit 142 determines whether the final transition destination of the node “S” is the one leaf node (S33). As shown in FIG. 14, the transition destination of the node “S” is only the leaf node “False”. In this case (S33: YES), the label operation unit 142 attaches the “False” label to the node “S” (S34).

The label operation unit 142 determines whether the final transition destination of the parent node “U” of the node “S” is the one leaf node (S35). As shown in FIG. 14, the transition destination of the node “U” is the node “S” labeled with “False”. That is, the final transition destination of the node “U” is the same leaf node “False” as the final transition destination of the node “S”. In this case (S35: YES), the node “U” is labeled with “False” (S34).

Subsequently, the label operation unit 142 determines whether the final transition destination of the parent node “R” of the node “U” is the one leaf node (S35). As shown in FIG. 17, the child nodes of the node “R” are the node “S” labeled with “False” and the leaf node “False”. That is, the final transition destination of the node “R” is only the leaf node “False”. In this case (S33: YES), the elimination unit 13 and the label operation unit 142 attach the “False” label to the node “R” (S34).

The label operation unit 142 determines whether the final transition destination of the parent nodes “Q” and “T” of the node “R” is the one leaf node (S35). As shown in FIG. 17, the nodes “Q” and “T” can reach any of the leaf node “True” and the leaf node “False”. In this case (S33: NO), the determination unit 14 determines whether the label is attached to the root node (S36). As shown in FIG. 17, the root node is not labeled. In this case (S36: NO), the determination unit 14 determines that there is reachability (S37).

(Case where Observed Event 51 is “¬T”)

The link operation unit 141 determines whether the child node of the node “T” is only one internal node (S31). As shown in FIG. 18, the child node of the node “T” is the node “R”. In this case (S31: YES), the link operation unit 141 attaches the link L2 to the node “R” on the node “T” (S32).

The label operation unit 142 determines whether the final transition destination of the node “T” is the one leaf node (S33). As shown in FIG. 18, the transition destination of the node “T” is the node “R” labeled with “False”. That is, the final transition destination of the node “T” is the leaf node “False”. In this case (S35: YES), the node “T” is labeled with “False” (S34).

Subsequently, the label operation unit 142 determines whether the final transition destination of the parent node “Q” of the node “T” is the one leaf node (S35). As shown in FIG. 18, the transition destination of the node “Q” is the nodes “T” and “R” labeled with “False”. That is, the final transition destination of the node “Q” is the leaf node “False”. In this case (S35: YES), the node “Q” is labeled with “False” (S34).

The label operation unit 142 determines whether the final transition destination of the parent node “P” of the node “Q” is the one leaf node (S35). As shown in FIG. 18, node “P” is reachable to both leaf node “True” and leaf node “False”. In this case (S33: NO), the determination unit 14 determines whether the label is attached to the root node (S36). As shown in FIG. 18, the root node is not labeled. In this case (S36: NO), the determination unit 14 determines that there is reachability (S37).

(Case where Observed Event 51 is “P”)

The link operation unit 141 determines whether the child node of the node “P” is only one internal node (S31). As shown in FIG. 19, the child node of the node “P” is the node “Q”. In this case (S31: YES), the link operation unit 141 attaches the link L3 to the node “Q” on the node “P” (S32).

The label operation unit 142 determines whether the final transition destination of the node “P” is the one leaf node (S33). As shown in FIG. 19, the transition destination of the node “P” is the node “Q” labeled with “False”. That is, the final transition destination of the node “P” is the leaf node “False”. In this case (S35: YES), the node “P” is labeled with “False” (S34).

The node “P” is a root node and has no parent node. In this case (S35: NO), the determination unit 14 determines whether the label is attached to the root node (S36). As shown in FIG. 19, the root node is labeled. In this case (S36: YES), the determination unit 14 determines that there is no reachability (S38).

### [Program]

It is sufficient for the program according to the example embodiment 2 of the present invention to be a program that causes a computer to execute steps S21 to S29 shown in FIG. 15 and steps S31 to S38 shown in FIG. 16. The contradiction detection apparatus 2 and the contradiction detection method according to the example embodiment 2 can be realized by installing this program in the computer and executing this program. In this case, a processor of the computer functions as the construction unit 11, the reception unit 12, the elimination unit 13, the determination unit 14, the repetition unit 15, the decision unit 16, the grounding operation unit 17, and the output unit 18 and performs processing.

Also, the program according to the example embodiment 2 may be executed by a computer system constituted by a plurality of computers. In this case, for example, each computer may function as any of the construction unit 11, the reception unit 12, the elimination unit 13, the determination unit 14, the repetition unit 15, the decision unit 16, the grounding operation unit 17, and the output unit 18.

### Effect in the Example Embodiment 2

According to the contradiction detection apparatus 1 according to the example embodiment 2, it is possible to find the contradiction of the observed event 51 with respect to the knowledge base 50. Further, in comparison with the example embodiment 1, by attaching the label of the final transition destination to each node, the reachability determination process can be speeded up. As a result, the processing time for detecting a contradiction can be shortened.

### [Physical Configuration]

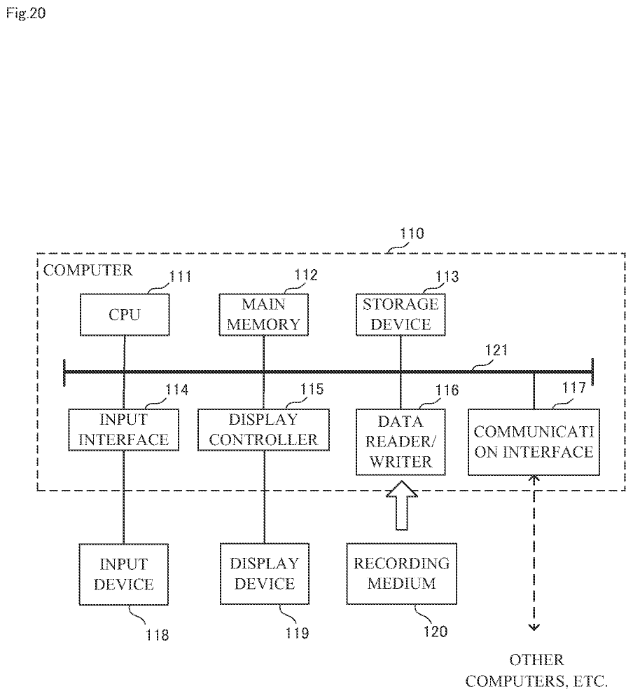

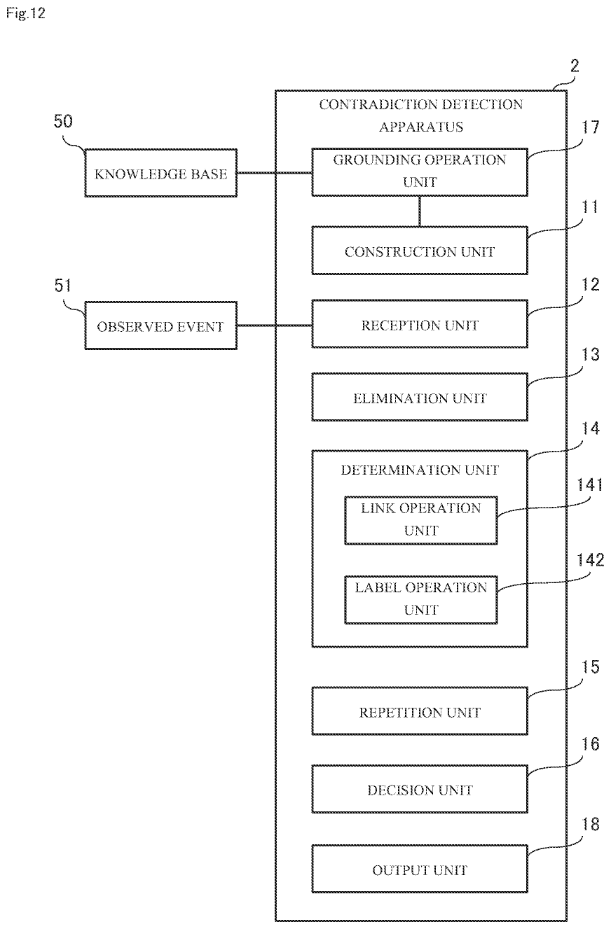

Here, a computer that realizes the contradiction detection apparatus by executing the programs in the example embodiments 1 and 2 will be described with reference to FIG. 20. FIG. 20 is a block diagram illustrating one example of a computer realizing the contradiction detection apparatus in the example embodiments 1 and 2.

As illustrated in FIG. 20, a computer 110 includes a CPU 111, a main memory 112, a storage device 113, an input interface 114, a display controller 115, a data reader/writer 116, and a communication interface 117. These components are connected via a bus 121 so as to be capable of performing data communication with one another. Note that the computer 110 may include a graphics processing unit (GPU) or a field-programmable gate array (FPGA) in addition to the CPU 111 or in place of the CPU 111.

The CPU 111 loads the programs (codes) in the example embodiments 1 and 2, which are stored in the storage device 113, onto the main memory 112, and performs various computations by executing these codes in a predetermined order. The main memory 112 is typically a volatile storage device such as a dynamic random access memory (DRAM). Furthermore, the programs in the example embodiments 1 and 2 are provided in a state such that the program is stored in a computer readable recording medium 120. Note that the programs in the example embodiments 1 and 2 may also be programs that are distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119.

The data reader/writer 116 mediates data transmission between the CPU 111 and the recording medium 120, and executes the reading out of the program from the recording medium 120 and the writing of results of processing in the computer 110 to the recording medium 120. The communication interface 117 mediates data transmission between the CPU 111 and other computers.

Furthermore, specific examples of the recording medium 120 include a general-purpose semiconductor storage device such as a CompactFlash (registered trademark, CF) card or a Secure Digital (SD) card, a magnetic recording medium such as a flexible disk, and an optical recording medium such as a compact disk read-only memory (CD-ROM).

Note that the contradiction detection apparatuses in the example embodiments 1 and 2 can also be realized by using pieces of hardware corresponding to the respective units, rather than using a computer on which the program is installed. Furthermore, a portion of the contradiction detection apparatus may be realized by using a program, and the remaining portion of the contradiction detection apparatus may be realized by using hardware.

While a part of or the entirety of the above-described example embodiment can be expressed by (Supplementary note 1) to (Supplementary note 15) described in the following, the invention is not limited to the following description.

### (Supplementary Note 1)

A contradiction detection apparatus that detects whether an observed event is inconsistent with a knowledge base, the contradiction detection apparatus comprising:

a construction means for constructing a decision graph that has observed events as nodes and a transition relationship of each observed event as an edge, and outputs a boolean value of an observed event based on the knowledge base,

a reception means for receiving an observed event,

an elimination means for eliminating an edge, which transitions to a side denying the observed event received by the reception means, among edges connected to a node corresponding to the observed event received by the reception means in the decision graph,

a determination means for determining whether both paths from a root node to a true leaf node and a false leaf node exist in the decision graph after the edge is eliminated by the elimination means,

a repetition means for causing the reception means, the elimination means, and the determination means to repeatedly execute processing when the determination means determines that the paths exist, and

a decision means for deciding that the observed event is inconsistent with the knowledge base when the determination means determines that the paths does not exist.

### (Supplementary Note 2)

The contradiction detection apparatus according to Supplementary note 1, further comprising:

an output means for outputting an observed event received by the reception means before a contradiction is decided when the determination means determines a contradiction.

### (Supplementary Note 3)

The contradiction detection apparatus according to Supplementary note 1 or 2, wherein

the determination means comprises:
a link operation means for putting a link to one internal node on a node having the one internal node as a child node, and
a label operation means for attaching a label of “True” or “False”, which corresponds to one leaf node, to a node having the one leaf node as a final transition destination, and wherein

the determination means determines that both paths from a root node to a true leaf node and a false leaf node do not exist when the label operation means attaches the label to the root node.

### (Supplementary Note 4)

The contradiction detection apparatus according to Supplementary note 3, wherein

when a final transition destination of a parent node of the node to which a label is attached by the label operation means, is only one leaf node, the label operation means attaches the label to the parent node.

### (Supplementary Note 5)

The contradiction detection apparatus according to any one of Supplementary notes 1 to 4, further comprising:

a grounding operation means for performing grounding operation based on Herbrand universe of the knowledge base, wherein

the construction means constructs the decision graph based on an operation result by the grounding operation means.

### (Supplementary Note 6)

A contradiction detection method that detects whether an observed event is inconsistent with a knowledge base, the method comprising:

constructing a decision graph that has observed events as nodes and a transition relationship of each observed event as an edge, and outputs a boolean value of an observed event based on the knowledge base,

receiving an observed event,

eliminating an edge, which transitions to a side denying the observed event received,

among edges connected to a node corresponding to the observed event received in the decision graph,

determining whether both paths from a root node to a true leaf node and a false leaf node exist in the decision graph after the edge is eliminated,

repeatedly executing a reception of the observed event, an elimination of the edge, and a determination of existence of the paths when it is determined that the paths exist, and

deciding that the observed event is inconsistent with the knowledge base when it is determined that the paths does not exist.

### (Supplementary Note 7)

The contradiction detection method according to Supplementary note 6, wherein

when the observed event is decided to be inconsistent, outputting an observed event received before a contradiction is decided.

### (Supplementary Note 8)

The contradiction detection method according to Supplementary note 6 or 7, wherein

when determining whether the paths exist:
putting a link to one internal node on a node having the one internal node as a child node, and
attaching a label of “True” or “False”, which corresponds to one leaf node, to a node having the one leaf node as a final transition destination, and
determining that both paths from a root node to a true leaf node and a false leaf node do not exist when the root node is labeled.

### (Supplementary Note 9)

The contradiction detection method according to Supplementary note 8, wherein

when a final transition destination of a parent node of the node to which the label is attached is only one leaf node, attaching the label to the parent node.

### (Supplementary Note 10)

The contradiction detection method according to any one of Supplementary notes 6 to 9, further comprising:

performing grounding operation based on Herbrand universe of the knowledge base, wherein

when constructing the decision graph, the decision graph is constructed based on an operation result of the grounding operation.

### (Supplementary Note 11)

A computer-readable recording medium that includes recorded thereon, a program including instructions that cause a computer, which detects whether an observed event is inconsistent with a knowledge base, to execute:

constructing a decision graph that has observed events as nodes and a transition relationship of each observed event as an edge, and outputs a boolean value of an observed event based on the knowledge base,

receiving an observed event,

eliminating an edge, which transitions to a side denying the observed event received, among edges connected to a node corresponding to the observed event received in the decision graph,

determining whether both paths from a root node to a true leaf node and a false leaf node exist in the decision graph after the edge is eliminated,

repeatedly executing a reception of the observed event, an elimination of the edge, and a determination of existence of the paths when it is determined that the paths exist, and

deciding that the observed event is inconsistent with the knowledge base when it is determined that the paths does not exist.

### (Supplementary Note 12)

The computer-readable recording medium according to Supplementary note 11, wherein

when the observed event is decided to be inconsistent, outputting an observed event received before a contradiction is decided.

### (Supplementary Note 13)

The computer-readable recording medium according to Supplementary note 11 or 12, wherein

when determining whether the paths exist:
putting a link to one internal node on a node having the one internal node as a child node, and
attaching a label of “True” or “False”, which corresponds to one leaf node, to a node having the one leaf node as a final transition destination, and
determining that both paths from a root node to a true leaf node and a false leaf node do not exist when the root node is labeled.

### (Supplementary Note 14)

The computer-readable recording medium according to Supplementary note 13, wherein

when a final transition destination of a parent node of the node to which the label is attached is only one leaf node, attaching the label to the parent node.

### (Supplementary Note 15)

The computer-readable recording medium according to any one of Supplementary notes 11 to 14, the program further including instructions that cause a computer to execute:

performing grounding operation based on Herbrand universe of the knowledge base, wherein

when constructing the decision graph, the decision graph is constructed based on an operation result of the grounding operation.

### INDUSTRIAL APPLICABILITY

As described above, the present invention is useful in in the field of deriving hypotheses by applying inferential knowledge to observed events.

### REFERENCE SIGNS LIST

1, 2 Contradiction detection apparatus
11 Construction unit
12 Reception unit
13 Elimination unit
14 Determination unit
15 Repetition unit
16 Decision unit
17 Grounding operation unit
18 Output unit
141 Link operation unit
142 Label operation unit

What is claimed is:

1. A contradiction detection apparatus that detects whether an observed event is inconsistent with a knowledge base, the contradiction detection apparatus comprising:
a construction unit that constructs a decision graph that has observed events as nodes and a transition relationship of each observed event as an edge, and outputs a boolean value of an observed event based on the knowledge base,
a reception unit that receives an observed event,
an elimination unit that eliminates an edge, which transitions to a side denying the observed event received by the reception unit, among edges connected to a node corresponding to the observed event received by the reception means unit in the decision graph,
a determination unit that determines whether both paths from a root node to a true leaf node and a false leaf node exist in the decision graph after the edge is eliminated by the elimination unit,
a repetition unit that causes the reception mea unit the elimination unit and the determination means unit to repeatedly execute processing when the determination means unit determines that the paths exist, and
a decision unit that decides that the observed event is inconsistent with the knowledge base when the determination means unit determines that the paths does not exist.

2. The contradiction detection apparatus according to claim 1, further comprising:
an output unit that outputs an observed event received by the reception unit before a contradiction is decided when the determination unit determines a contradiction.

3. The contradiction detection apparatus according to claim 1, wherein
the determination unit comprises:
a link operation unit that puts a link to one internal node on a node having the one internal node as a child node, and
a label operation unit that attaches a label of “True” or “False”, which corresponds to one leaf node, to a node having the one leaf node as a final transition destination, and wherein
the determination unit determines that both paths from a root node to a true leaf node and a false leaf node do not exist when the label operation unit attaches the label to the root node.

4. The contradiction detection apparatus according to claim 3, wherein
when a final transition destination of a parent node of the node to which a label is attached by the label operation unit, is only one leaf node, the label operation unit attaches the label to the parent node.

5. The contradiction detection apparatus according to claim 1, further comprising:
a grounding operation unit that performs grounding operation based on Herbrand universe of the knowledge base, wherein
the construction unit constructs the decision graph based on an operation result by the grounding operation unit.

6. A contradiction detection method that detects whether an observed event is inconsistent with a knowledge base, the method comprising:
constructing a decision graph that has observed events as nodes and a transition relationship of each observed event as an edge, and outputs a boolean value of an observed event based on the knowledge base,
receiving an observed event,
eliminating an edge, which transitions to a side denying the observed event received, among edges connected to a node corresponding to the observed event received in the decision graph,
determining whether both paths from a root node to a true leaf node and a false leaf node exist in the decision graph after the edge is eliminated,
repeatedly executing a reception of the observed event, an elimination of the edge, and a determination of existence of the paths when it is determined that the paths exist, and
deciding that the observed event is inconsistent with the knowledge base when it is determined that the paths does not exist.

7. The contradiction detection method according to claim 6, wherein
when the observed event is decided to be inconsistent, outputting an observed event received before a contradiction is decided.

8. The contradiction detection method according to claim 6, wherein
when determining whether the paths exist:
putting a link to one internal node on a node having the one internal node as a child node, and
attaching a label of “True” or “False”, which corresponds to one leaf node, to a node having the one leaf node as a final transition destination, and
determining that both paths from a root node to a true leaf node and a false leaf node do not exist when the root node is labeled.

9. The contradiction detection method according to claim 8, wherein
when a final transition destination of a parent node of the node to which the label is attached is only one leaf node, attaching the label to the parent node.

10. The contradiction detection method according to claim 6, further comprising:
performing grounding operation based on Herbrand universe of the knowledge base, wherein
when constructing the decision graph, the decision graph is constructed based on an operation result of the grounding operation.

11. A non-transitory computer-readable recording medium that includes recorded thereon, a program including instructions that cause a computer, which detects whether an observed event is inconsistent with a knowledge base, to execute:
constructing a decision graph that has observed events as nodes and a transition relationship of each observed event as an edge, and outputs a boolean value of an observed event based on the knowledge base,
receiving an observed event,
eliminating an edge, which transitions to a side denying the observed event received, among edges connected to a node corresponding to the observed event received in the decision graph,
determining whether both paths from a root node to a true leaf node and a false leaf node exist in the decision graph after the edge is eliminated,
repeatedly executing a reception of the observed event, an elimination of the edge, and a determination of existence of the paths when it is determined that the paths exist, and
deciding that the observed event is inconsistent with the knowledge base when it is determined that the paths does not exist.

12. The non-transitory computer-readable recording medium according to claim 11, wherein
when the observed event is decided to be inconsistent, outputting an observed event received before a contradiction is decided.

13. The non-transitory computer-readable recording medium according to claim 11, wherein
when determining whether the paths exist:
putting a link to one internal node on a node having the one internal node as a child node, and
attaching a label of “True” or “False”, which corresponds to one leaf node, to a node having the one leaf node as a final transition destination, and
determining that both paths from a root node to a true leaf node and a false leaf node do not exist when the root node is labeled.

14. The non-transitory computer-readable recording medium according to claim 13, wherein
when a final transition destination of a parent node of the node to which the label is attached is only one leaf node, attaching the label to the parent node.

15. The non-transitory computer-readable recording medium according to claim 11, the program further including instructions that cause a computer to execute:
performing grounding operation based on Herbrand universe of the knowledge base, wherein
when constructing the decision graph, the decision graph is constructed based on an operation result of the grounding operation.
